(19) United States
(12) Patent Application Publication
(10) Pub. No.: US 2022/0165042 A1
(43) Pub. Date: May 26, 2022

(54) THREE-DIMENSIONAL SHAPE DESIGN SYSTEM AND THREE-DIMENSIONAL SHAPE DESIGN METHOD

(71) Applicant: TOYOTA JIDOSHA KABUSHIKI KAISHA, Toyota-shi (JP)

(72) Inventor: Takashi AOYAMA, Anjo-shi (JP)

(73) Assignee: TOYOTA JIDOSHA KABUSHIKI KAISHA, Toyota-shi (JP)

(21) Appl. No.: 17/508,286

(22) Filed: Oct. 22, 2021

(30) Foreign Application Priority Data
Nov. 20, 2020 (JP) 2020-193245

(51) Int. Cl. G06T 19/20

(52) U.S. Cl. CPC G06T 19/20; G06T 2219/024; G06T 2219/2021

(57) ABSTRACT

A three-dimensional shape design system is a system for performing concurrent modeling of the same three-dimensional model by a plurality of designers. The method includes: a duplication unit configured to specify a part-to-be-verified which is a part of the three-dimensional model based on input made by the respective designers and duplicate shape information and coordinate information of the part-to-be-verified; a change unit configured to change the duplicated shape information based on the content of input by the respective designers; and a display control unit configured to display a shape based on the changed shape information and the three-dimensional model in a superimposed manner when the three-dimensional model is displayed on a display unit.

### CROSS REFERENCE TO RELATED APPLICATIONS

This application is based upon and claims the benefit of priority from Japanese patent application No. 2020-193245, filed on Nov. 20, 2020, the disclosure of which is incorporated herein in its entirety by reference.

### BACKGROUND

The present disclosure relates to a three-dimensional shape design system and a three-dimensional shape design method.

There are cases where a plurality of designers jointly design a three-dimensional shape. Japanese Unexamined Patent Application Publication No. H06-068210 explains that when a plurality of designers are involved in creating a three-dimensional model, information is shared among the plurality of designers by sharing the design history.

### SUMMARY

When a plurality of designers are involved in designing a three-dimensional shape, there are cases where the plurality of designers verify the same three-dimensional model. In the conventional technique, information was shared by referring to the design history of each designer, which required each designer to update the three-dimensional model temporarily in order to leave a record of his/her design history.

For instance, a case where two designers, a designer A and a designer B, are creating a three-dimensional model is considered. When the designer A updates (i.e. modifies) the three-dimensional model and then the designer B verifies the shape of the updated three-dimensional model, a case may arise in which the designer A needs to re-verify the shape of the three-dimensional model depending on the content of verification by the designer B. In such a case, the time required for designing the three-dimensional model increases by the time taken for the designer A to re-verify the shape of the three-dimensional model. Further, when the designer A and the designer B verify the shape of the three-dimensional model concurrently, a case may arise in which the version of the three-dimensional model verified by the designer A differs from the version of the three-dimensional model verified by the designer B depending on the timing at which each designer updated the three-dimensional model, causing discrepancies in the recognition as regards the shape of the three-dimensional model between that of the designer A and that of the designer B. Therefore, in such a case, designing needs to be re-done, which may result in longer time taken to design the three-dimensional model.

The present disclosure has been made in order to solve the problem mentioned above, and provides a three-dimensional shape design system and a three-dimensional shape design method for allowing a plurality of designers to make a shape change to a part of a three-dimensional model independently from the other parts thereof.

A three-dimensional shape design system according to an embodiment is a three-dimensional shape design system for performing concurrent modeling of the same three-dimensional model by a plurality of designers, the method including:

duplication means for specifying a part-to-be-verified which is a part of the three-dimensional model based on input made by the respective designers and duplicating shape information and coordinate information of the part-to-be-verified; change means for changing the duplicated shape information based on the content of input by the respective designers; and display control means for displaying a shape based on the changed shape information and the three-dimensional model in a superimposed manner when the three-dimensional model is displayed on a display apparatus.

A three-dimensional shape design method according to an embodiment is a three-dimensional shape design method for performing concurrent modeling of the same three-dimensional model by a plurality of designers, the method including:

a duplication step of specifying a part-to-be-verified which is a part of the three-dimensional model based on input made by the respective designers and duplicating shape information and coordinate information of the part-to-be-verified;

a changing step of changing the duplicated shape information based on the content of input by the respective designers; and

a display control step of displaying a shape based on the changed shape information and the three-dimensional model in a superimposed manner when the three-dimensional model is displayed on a display apparatus.

According to the present disclosure, a three-dimensional shape design system and a three-dimensional shape design method for allowing a plurality of designers to make a shape change to a part of the three-dimensional model independently from the other parts thereof.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing an example of a configuration of a three-dimensional shape design system according to an embodiment;

FIG. 2 is a block diagram showing a configuration of a server according to an embodiment;

FIG. 3 is a block diagram showing a configuration of a terminal according to an embodiment;

FIG. 4 is a schematic diagram illustrating a display screen displayed on a terminal according to an embodiment;

FIG. 5 is a flowchart showing the flow of a three-dimensional shape design method according to an embodiment;

FIG. 6 is a flowchart showing the flow of a three-dimensional shape design method according to an embodiment; and

FIG. 7 is a flowchart showing the flow of a three-dimensional shape design method according to an embodiment.

### DESCRIPTION OF EMBODIMENTS

Hereinbelow, the present disclosure will be described through embodiments of the disclosure. However, the embodiments are not intended to limit the scope of the present disclosure according to the claims. Further, not all of the configurations described in the embodiments are necessarily indispensable as means for solving the problem.

Hereinbelow, a three-dimensional shape design system according to an embodiment will be described with reference to the drawings. A three- dimensional shape design system 1000 according to the embodiment is a system that enables a plurality of designers to perform concurrent modeling of a three-dimensional model. For instance, there may be a case where one three-dimensional model is jointly designed by a designer who designs the model from the viewpoint of strength and a designer who designs the model from the viewpoint of productivity.

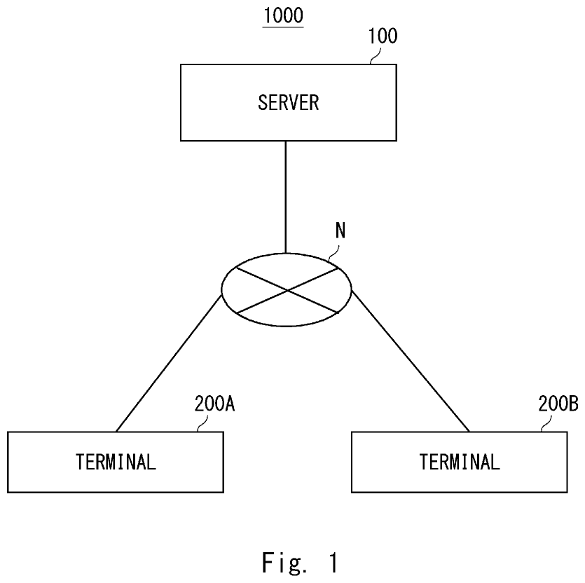

FIG. 1 is a block diagram showing an example of a configuration of the three-dimensional shape design system 1000. The three-dimensional shape design system 1000 includes a server 100, a terminal 200A, and a terminal 200B. The terminal 200A is an information terminal operated by a designer A and the terminal 200B is a terminal operated by a designer B. The three-dimensional shape design system 1000 may further include a terminal (not shown) for the designer A and the designer B to verify the shape of three-dimensional model in the presence of each other. Note that when the designers A and B are not distinguished from each other, they are simply referred to as the designer(s). Note that when the terminal 200A and the terminal 200B are not distinguished from each other, they are simply referred to as the terminal(s) 200. Each terminal 200 is, for instance, an information terminal such as a PC (Personal Computer). Note that the three-dimensional design system 1000 may include three or more terminals 200. For instance, the three-dimensional design system 1000 may include a terminal 200C operated by a designer C.

The server 100, the terminal 200A, and the terminal 200B are connected to one another via a network N. The network N may be a wired network or a radio network.

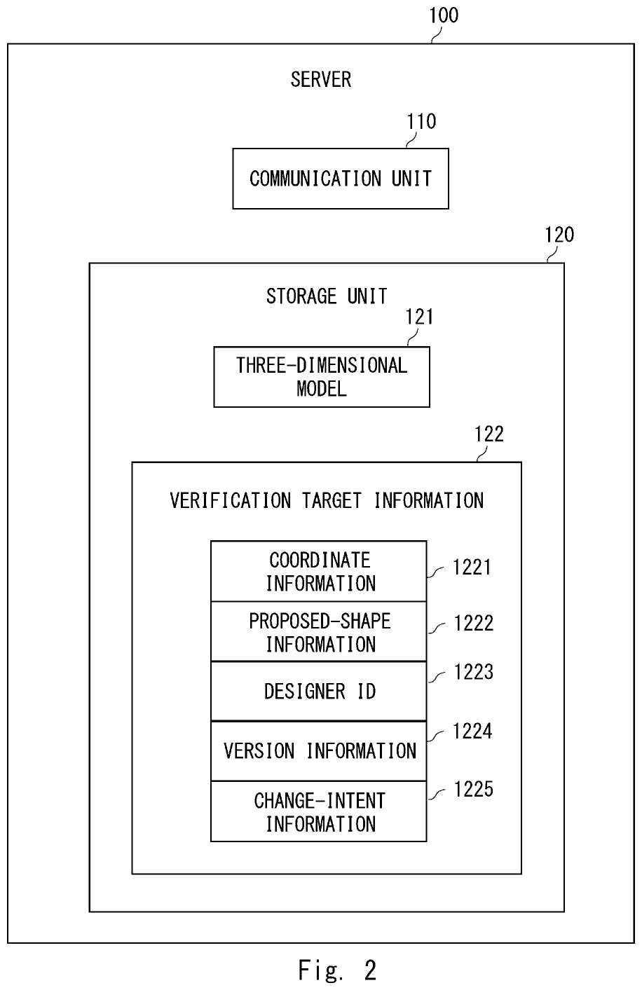

FIG. 2 is a block diagram showing a configuration of the server 100. The server 100 includes a communication unit 110 and a storage unit 120. The communication unit 110 is a communication interface with the network N.

The storage unit 120 is configured of non-volatile storage devices such as an SSD (Solid State Drive) and a hard disk drive. The storage unit 120 may also include a RAM (Random Access Memory). The storage unit 120 may also be referred to as a storage apparatus. The storage unit 120 stores a three-dimensional model 121 designed by the designers A and B. The three-dimensional model 121 is the target of concurrent modeling performed by the designers A and B. The three-dimensional model 121 is associated with information on the target to be verified 122 (hereinafter referred to as the verification target information 122) to be described later. For instance, the verification target information 122 is included in an assembly file of the three-dimensional model 121.

Further, the storage unit 120 stores the verification target information 122 related to a part X of the three-dimensional model to be verified (hereinafter referred to as the part-to-be-verified X). The part-to-be-verified X is a part of the three-dimensional model 121, and is the part which the designer A or the designer B is proposing a change in the shape of. The storage unit 120 may store a plurality of pieces of the verification target information 122. In the case where the storage unit 120 stores a plurality of pieces of the verification target information 122, each piece of the verification target information 122 may be given an ID. For instance, the storage unit 120 may store a part-to-be-verified XA for which the designer A is proposing a change in the shape and a part-to-be-verified XB for which the designer B is proposing a change in the shape.

The verification target information 122 includes coordinate information 1221, proposed-shape information 1222, a designer ID 1223, version information 1224, and information on the intended change 1225 (hereinafter referred to as the change-intent information 1225). The coordinate information 1221 is coordinate information representing the position of the part-to-be-verified X within the three-dimensional model 121. The proposed-shape information 1222 is shape information regarding the shape proposed by the designer A or the designer B. The shape information is also referred to as the geometry (group of information items for configuring the planes, edges, etc.). The shape information is, for instance, information related to planes, angles, and the like. The terminal 200 to be described later duplicates the shape information of the part-to-be-verified X and changes the duplicated shape information, thereby generating the proposed-shape information 1222.

The designer ID 1223 is an ID of a designer who registered the verification target information 122. It can also be said that the designer ID is an ID of the designer who is proposing a change in the shape of the three-dimensional model. The version information 1224 is information indicating the version of the three-dimensional model 121 when the verification target information 122 was registered. The change-intent information 1225 is information indicating the intention of the designer who intends to make a shape change to a part of the three-dimensional model. Each of the designer ID 1223, the version information 1224, and the change-intent information 1225 may be information at the time the shape information was duplicated by a duplication unit 242 to be described later.

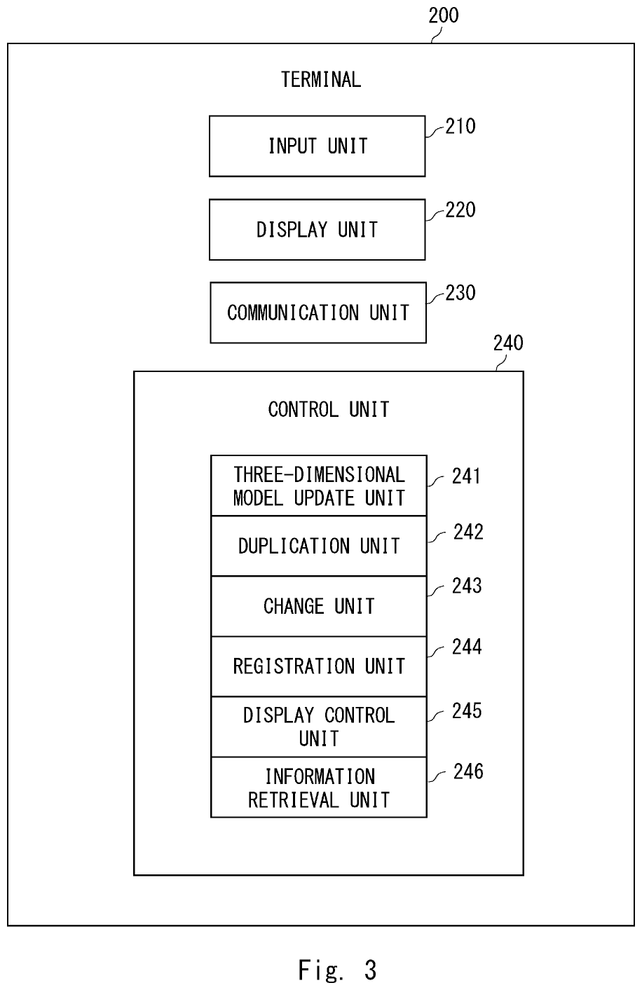

FIG. 3 is a block diagram showing a configuration of the terminal 200. The terminal 200 includes an input unit 210, a display unit 220, a communication unit 230, and a control unit 240. The input unit 210 is an input interface connected to input devices such as a keyboard, a mouse, and the like. The display unit 220 is a display apparatus such as a display. The communication unit 230 is a communication interface with the network N.

The control unit 240 is a control apparatus that controls each hardware mentioned above. The control unit 240 includes a three-dimensional model update unit 241, the duplication unit 242, a change unit 243, a registration unit 244, a display control unit 245, and an information retrieval unit 246.

The three-dimensional model update unit 241 changes the shape of the three-dimensional model 121 stored in the server 100 based on the content of input by each designer to the input unit 210 and updates the three-dimensional model 121. Updating the three-dimensional model 121 can be rephrased as advancing the version of the file of the three-dimensional model 121. When the verification target information 122 is included in the assembly file of the three-dimensional model 121, the verification target information 122 is also included in the assembly file of the updated three-dimensional model 121.

The duplication unit 242 specifies the part-to-be-verified X which is a part of the three-dimensional model 121 based on the content of input by each designer to the input unit 210 and duplicates the coordinate information 1221 of the part-to-be-verified X and the shape information. The duplication unit 242 may duplicate the shape information and the like by specifying a part of the three-dimensional model which a designer has selected using a mouse and the like as the part-to-be-verified X. The duplicated coordinate information 1221 and the shape information are not associated with the three-dimensional model 121. That is, the shape information remains unchanged even when the shape of the three-dimensional model 121 is changed, and the shape of the three-dimensional model remains unchanged even when the shape information is changed. In other words, the duplicated coordinate information 1221 and the shape information are independent from (not associated with) the three-dimensional model 121.

The change unit 243 changes the shape information of the part-to-be-verified X based on the content of input by each designer to the input unit 210 and generates the proposed-shape information 1222. Note that the proposed-shape information 1222 is generated in accordance with the operation procedure that is the same as the operation procedure of the creation of the three-dimensional model 121. Owing to the functions of the duplication unit 242 and the change unit 243, each designer can create the proposed shape without having to update the three-dimensional model 121 whereby it is possible to reduce the aforementioned discrepancies in the recognition as regards the shape of the three-dimensional model between that of the respective designers. Further, by this configuration, it is possible to save each designer from having to update the three-dimensional model 121 and to create the change history.

The duplication unit 242 duplicates only the shape information and the like of a part of the three-dimensional model 121. Therefore, according to the present embodiment, it is possible to perform the processing of displaying, changing, and the like of a part of the three-dimensional model 121 in a shorter period of time than the time taken to perform the same of the whole three-dimensional model 121. Further, since only the shape information of a part of the three-dimensional model is duplicated, there is an advantage that it is easy to ascertain the changed part when the three-dimensional model 121 is displayed by the display control unit 245 to be described later.

The registration unit 244 registers the coordinate information 1221 duplicated by the duplication unit 242 and the proposed-shape information 1222 generated by the change unit 243 in the storage unit 120 of the server 100. The registration unit 244 is also referred to as an information recording unit. The registration unit 244 may register the coordinate information 1221 and the proposed-shape information 1222 in the assembly file of the three-dimensional model 121. By this configuration, when the three-dimensional model update unit 241 updates the three-dimensional model 121, the coordinate information 1221 and the proposed-shape information 1222 will be included in the updated file.

When registering the coordinate information 1221 and the proposed-shape information 1222 in the storage unit 120, the registration unit 244 writes the ID of the designer who operates the terminal 200 as the designer ID 1223, the version of the three-dimensional model 121 as the version information 1224, and the information indicating the shape change which the designer who operates the terminal 200 intends to make to the three-dimensional model into the storage unit 120 of the server 100 as the change-intent information 1225. Note that at the time of registration, the registration unit 244 may cause the display unit 220 to display an input screen for entering comments and write the entered comments as the change-intent information 1225 into the server 100. By this configuration, when a plurality of pieces of the proposed-shape information 1222 are registered, it is possible to extract the proposed-shape information 1222 which one wants to confirm using the information retrieval unit 246 to be described later.

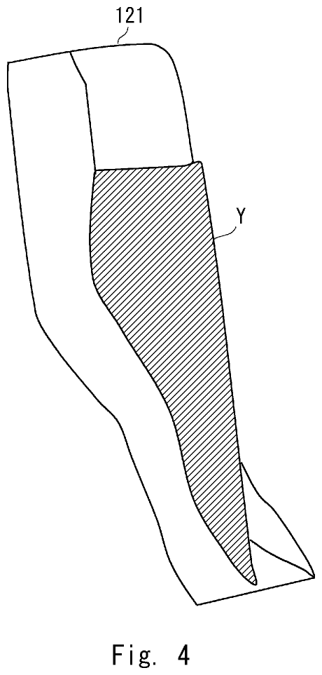

The display control unit 245 causes the display unit 220 to display the shape based on the proposed-shape information 1222 and the three-dimensional model 121 in a superimposed manner when displaying the three-dimensional model 121 on the display unit 220. The display control unit 245 causes the display unit 220 to display the shape based on the proposed-shape information 1222 at a position represented by the coordinate information 1221. By this configuration, the designers A and B can proceed with the design work while sharing information whereby it is possible to reduce the number of times of re-doing the designing. FIG. 4 is a schematic diagram illustrating an example of a display by the display control unit 245. In FIG. 4, the three-dimensional model 121 and the proposed shape Y that is hatched are displayed in a superimposed manner.

The information retrieval unit 246 searches the storage unit 120 of the server 100 using any one of the designer ID 1223, the version information 1224, and the change-intent information 1225. The information retrieval unit 246 may, for instance, extract the change-intent information 1225 which includes a prescribed expression. When a plurality of proposed shapes are displayed on the display unit 220, each designer can confirm the proposed shape change to be made to the three-dimensional model as necessary in accordance with the result of the search.

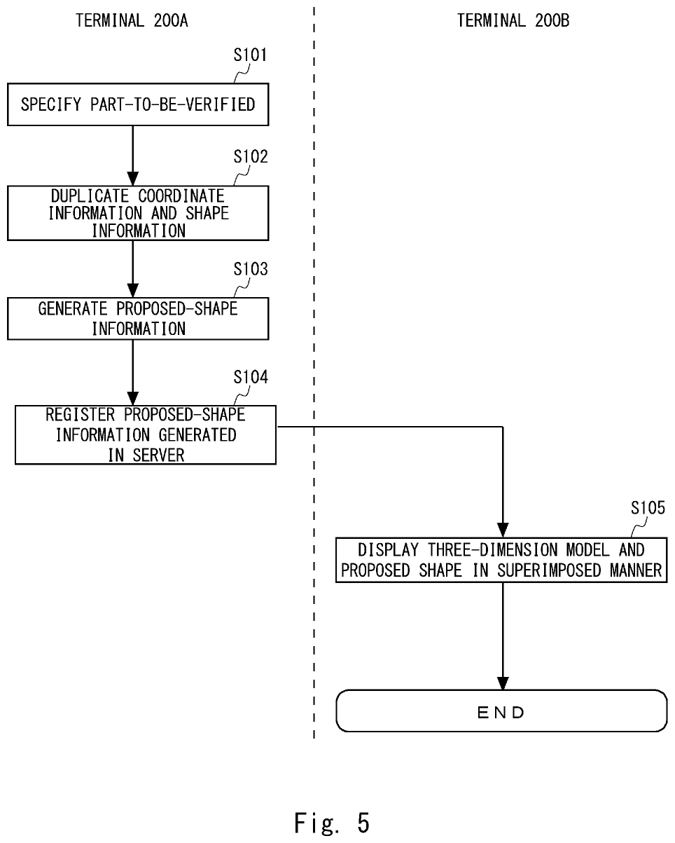

FIG. 5 is a flowchart illustrating the flow of a three-dimensional shape design method according to an embodiment. First, the designer A displays the three-dimensional model 121 on the display unit 220 of the terminal 200A. Then, the designer A confirms the three-dimensional model 121 and verifies the design, checking whether there is any part of the three-dimensional model 121 for which the shape needs to be changed. When there is a part of the three-dimensional model 121 for which the shape needs to be changed, the designer A uses an input device such as a mouse to select the part of the three-dimensional model 121 for which the shape needs to be changed. The selected part is the part-to-be-verified X. Then, the duplication unit 242 of the terminal 200A specifies the part-to-be-verified X in accordance with the content of input by the designer A to the input unit 210 (Step S101) and duplicates the coordinate information 1221 and the shape information of the part-to-be-verified X based on the three-dimensional model 121 (Step S102).

Next, the designer A changes the shape information duplicated in Step S102 and creates the proposed shape using an input device such as a mouse. For instance, when the shape based on the shape information duplicated in Step S102 is displayed on the display unit 220 of the terminal 200A, the designer A may create the proposed shape in accordance with the operation procedure that is the same as the operation procedure of the creation of the three-dimensional model 121. The change unit 243 of the terminal 200A generates the proposed-shape information 1222 in accordance with the shape information based on the content of input by the designer A to the input unit 210 (Step S103). Note that the shape information is not associated with the three-dimensional model 121, and thus the shape of the three-dimensional model 121 itself is not changed.

Next, the registration unit 244 registers the coordinate information 1221 and the proposed-shape information 1222 generated in Step S103 in the storage unit 120 of the server 100 (Step S104). Here, the registration unit 244 may further register the designer ID 1223, the version information 1224, and the change-intent information 1225 in the storage unit 120.

Then, the terminal 200B operated by the designer B displays the proposed shape based on the proposed-shape information 1222 registered in Step S104 when displaying the three-dimensional model 121 on the display unit 220 (Step S105). The designer B can perform design work while confirming the shape proposed by the designer A. In such a case, as in Steps S101 to S104, the terminal 200B registers the proposed shape created by the designer B in the server. By this configuration, the designers A and B can proceed with the design work while sharing information.

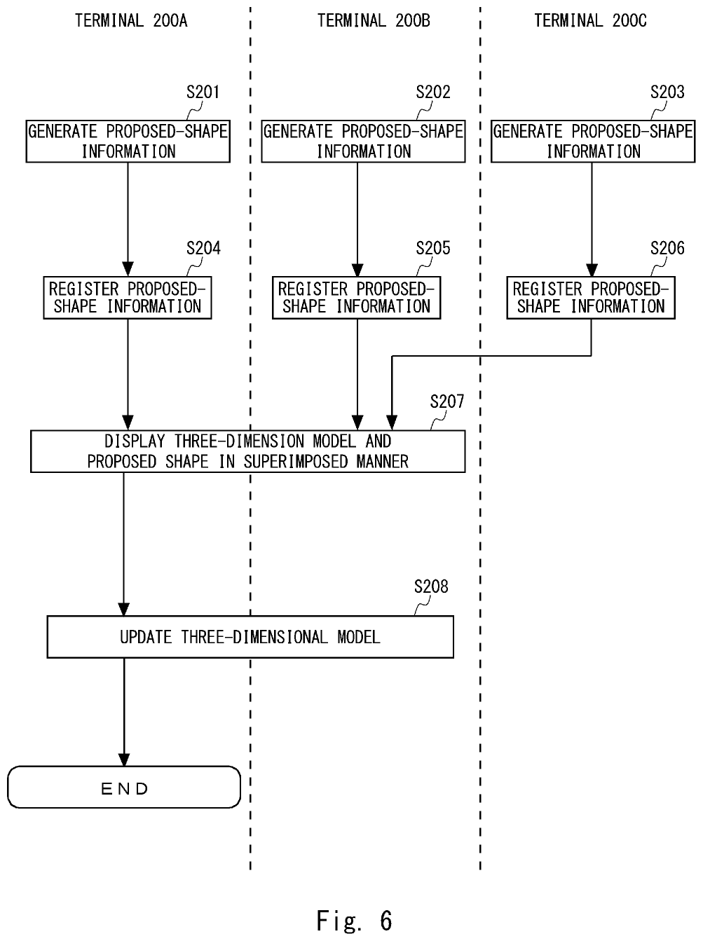

FIG. 6 is a flowchart illustrating an example of the flow of a method in which a plurality of designers simultaneously participate in designing, using the three-dimensional shape design system 1000. Simultaneous participation in designing is also referred to as SE (Simultaneous Engineering). Suppose three designers, i.e., the designers A, B, and C, perform the design work. The terminal operated by the designer C is referred to as the terminal 200C.

First, each of the designers A, B, and C duplicates the shape information and the like for the part of the three-dimensional model for which a change in the shape is to be proposed and changes the duplicated shape information. That is, the designers concurrently create their own respective proposed shapes. The terminals generate the proposed-shape information 1222 based on the content of input by the designers to the respective terminals (Steps S201 to S203) and register the generated proposed-shape information in the server 100 (Steps S204 to S206). Here, the registration unit 244 of each terminal registers the designer ID 1223 of each designer who operates a respective one of the terminals in the server 100. Here, since each designer uses the shape information duplicated from the three-dimensional model 121, concurrent work by a plurality of designers is possible.

Each of the designers A, B, and C confirms the other designers' created proposed shapes and proceeds with the design work, and determines whether or not it is necessary for the designers other than himself/herself to simultaneously participate in designing the three-dimensional model 121. For instance, when two different shapes are proposed for the same part-to-be-verified X, it may be determined that the designers of those shapes need to simultaneously participate in designing the three-dimensional model. Each designer can ascertain the other designers who have created each of the respective proposed shapes by searching the storage unit 120 of the server 100 using the information retrieval unit 246, and thus it is possible for each designer to determine with which one of the other designers he/she needs to simultaneously participate with in designing.

Suppose the designer A and the designer B verify the shape of the three-dimensional model in the presence of each other. The verification of the shape of the three-dimensional model may be performed via the terminal 200A or the terminal 200B, or may be performed via another terminal. Suppose that the designer C is not present when the verification is performed. In such a case, the display unit 220 of the terminal through which the simultaneous designing is performed displays the three-dimensional model 121, the proposed shape created by the designer A, the proposed shape created by the designer B, and the proposed shape created by the designer C (Step S207). Then, the designers A and B confirm the shapes proposed by each other for the part of the three-dimensional model for which verification of the shape is to be performed and reach an agreement as to what kind of shape is to be adopted. The three-dimensional model update unit 241 updates the three-dimensional model 121 in accordance with the operation of the terminal performed by the designer A or B (Step S208). By this configuration, each designer can proceed with the design work without having to wait for the other designer's design work.

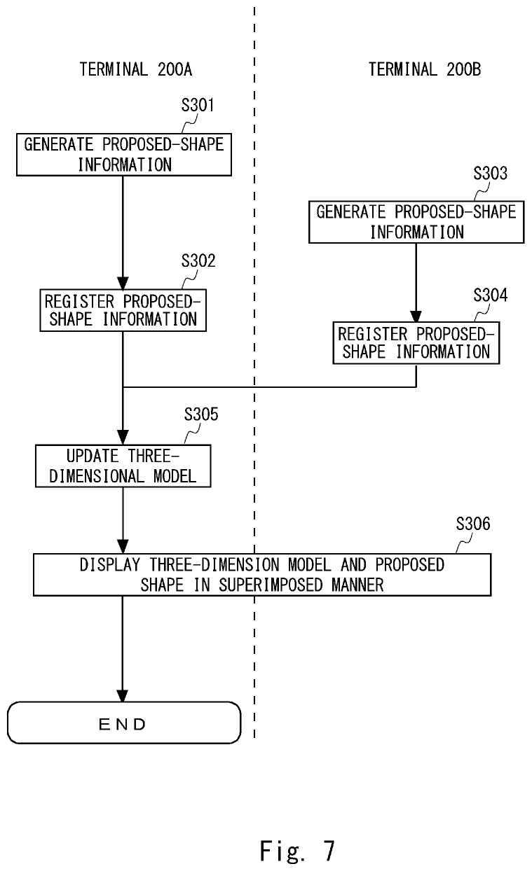

Next, referring to FIG. 7, a case in which each designer individually updates the three-dimensional model 121 will be described. Suppose the storage unit 120 of the server 100 stores the fifth version of the three-dimensional model 121. The designer A confirms the fifth version of the three-dimensional model 121, duplicates the part of the three-dimensional model for which the shape needs to be changed and creates a proposed shape. The terminal 200A generates the proposed-shape information 1222 (Step S301) and registers the generated information in the server (Step S302).

The designer B confirms the fifth version of the three-dimensional model 121, duplicates the part of the three-dimensional model for which the shape needs to be changed, and creates a proposed shape. The terminal 200B generates the proposed-shape information 1222 (Step S303) and registers the generated information in the server 100 (Step S304).

Next, the designer A reflects the proposed shape he/she has created in the three-dimensional model 121. The three-dimensional model update unit 241 updates the three-dimensional model 121 and the version of the three-dimensional model 121 is upgraded to the sixth version (Step S305). The sixth version of the three-dimensional model 121 includes the proposed-shape information 1222 proposed by the designer A and the proposed-shape information 1222 proposed by the designer B.

Therefore, when the sixth version of the three-dimensional model 121 is displayed, the terminal 200 displays the proposed shape proposed by the designer A, the proposed shape proposed by the designer B, and the three-dimensional model 121 (Step S306). Here, the shape proposed by the designer A and the sixth version of the three-dimensional model 121 are displayed in a superimposed manner whereby the designer B can ascertain that the three-dimensional model 121 reflects the shape proposed by the designer A.

Finally, the effect of the present embodiment will be explained. In a case where a design is verified from various points of view when designing a product, information needs to be shared among a plurality of designers. In designing a product using a three-dimensional model, there has been a problem that it is difficult to share information among the designers since there are many points that need to be verified and the shape of the three-dimensional model 121 changes as the design work proceeds. The three-dimensional shape design system according to the present embodiment can display a shape of the three-dimension model proposed by each designer and the three-dimensional model in a superimposed manner. Accordingly, the design work is streamlined and it is possible to avoid extension of the time needed to design the three-dimensional model.

The program to be executed by the three-dimensional shape design system 1000 can stored using any type of non-transitory computer-readable media and provided to a computer. The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The present disclosure is not limited to the above-described embodiments, and various modifications can be made without departing from the spirit and scope of the present invention.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A three-dimensional shape design system for performing concurrent modeling of the same three-dimensional model by a plurality of designers, the system comprising:
duplication means for specifying a part-to-be-verified which is a part of the three-dimensional model based on input made by the respective designers and duplicating shape information and coordinate information of the part-to-be-verified;
change means for changing the duplicated shape information based on the content of input by the respective designers; and
display control means for displaying a shape based on the changed shape information and the three-dimensional model in a superimposed manner when the three-dimensional model is displayed on a display apparatus.

2. The three-dimensional shape design system according to claim 1 further comprising registration means for registering at least one of version information indicating a version of the three-dimensional model, identification information of the respective designers, and change-intent information indicating the intention of the designer who intends to make a shape change to the three-dimensional model.

3. The three-dimensional shape design system according to claim 2 further comprising information retrieval means for searching the storage apparatus using any one of the version information, the identification information, and the change-intent information.

4. The three-dimensional shape design system according to claim 2, wherein the registration means registers the changed shape information and the coordinate information in an assembly file of the three-dimensional model.

5. A three-dimensional shape design method for performing concurrent modeling of the same three-dimensional model by a plurality of designers, the method comprising:
a duplication step of specifying a part-to-be-verified which is a part of the three-dimensional model based on input made by the respective designers and duplicating shape information and coordinate information of the part-to-be-verified;
a changing step of changing the duplicated shape information based on the content of input by the respective designers; and
a display control step of displaying a shape based on the changed shape information and the three-dimensional model in a superimposed manner when the three-dimensional model is displayed on a display apparatus.

6. A three-dimensional shape design system for performing concurrent modeling of the same three-dimensional model by a plurality of designers, the system comprising:
a duplication unit configured to specify a part-to-be-verified which is a part of the three-dimensional model based on input made by the respective designers and to duplicate shape information and coordinate information of the part-to-be-verified;
a change unit configured to change the duplicated shape information based on the content of input by the respective designers; and
a display control unit configured to display a shape based on the changed shape information and the three-dimensional model in a superimposed manner when the three-dimensional model is displayed on a display apparatus.
